(19) United States
(12) Patent Application Publication
(10) Pub. No.: US 2016/0300258 A1
(43) Pub. Date: Oct. 13, 2016

(54) DIGITAL TRANSACTION METHOD AND DEVICE

(71) Applicant: INDUSTRIAL TECHNOLOGY RESEARCH INSTITUTE, Hsinchu (TW)

(72) Inventors: Chih-Wei CHAO, Taichung City (TW); Kuei-Kai SHAO, Taipei City (TW); Kuo-Shu LUO, Hsinchu City (TW)

(73) Assignee: INDUSTRIAL TECHNOLOGY RESEARCH INSTITUTE, Hsinchu (TW)

(21) Appl. No.: 14/972,028

(22) Filed: Dec. 16, 2015

(30) Foreign Application Priority Data
Apr. 8, 2015 (TW) 104111242

(51) Int. Cl. G06Q 30/02; H04L 29/08

(52) U.S. Cl. CPC G06Q 30/0225; G06Q 30/0235; H04L 67/18

(57) ABSTRACT

A digital transaction method is applied in a user device. The user device instructs a digital transaction management server system to bind a device identification code of the user device and an order after the user device purchases with the digital transaction management server system and accordingly obtains the order. The user device generates a digital certification and a safety code, wherein the safety code varies according to a predetermined varying sequence during a predetermined time interval. After the safety code passes through an electronic verification of a service provider, the user device requests the service provider to settle an electronic transaction.

This application claims the benefit of Taiwan application Serial No. 104111242, filed Apr. 8, 2015, the disclosure of which is incorporated by reference herein in its entirety.

### TECHNICAL FIELD

The disclosure relates in general to a digital transaction method and device.

### BACKGROUND

In real life, the consumer behavior of purchasing physical consumption vouchers from the shops or purchasing electronic service/meal vouchers via Internet has become more and more popular. Related research shows that from now onward, the global number of people using mobile tickets/electronic tickets will keep breaking records. In Taiwan, research also shows that the amount of money of transactions using electronic tickets is increasing continuously.

Therefore, how to provide more convenience and higher anti-counterfeiting performance to consumers and service providers (such as shops) when it comes to the use and verification of mobile tickets, electronic tickets and digital certification has become a prominent task for the industries.

### SUMMARY

The disclosure is directed to a digital transaction method and device. The user device generates a digital certification and a safety code which varies with time. The service provider scans and verifies the safety code. If the verification is passed, then the service provider obtains information related to the user's order from the management server system according to the user device identification code obtained by analyzing the digital certification and further provides service/product based on the order to the user.

According to one embodiment, a digital transaction method applied in a user device is provided. The user device instructs a digital transaction management server system to bind a device identification code of the user device and an order after the user device purchases with the digital transaction management server system and accordingly obtains the order. The user device generates a digital certification and a safety code, wherein the safety code varies according to a predetermined varying sequence during a predetermined time interval. After the safety code passes through an electronic verification of a service provider, the user device requests the service provider based on the order to settle an electronic transaction.

According to another embodiment, a digital transaction method applied in a service provider device is provided. After a user device generates a digital certification and a safety code, the service provider device scans the digital certification and the safety code to verify whether the safety code varies according to a predetermined varying sequence during a predetermined time interval. If the service provider device determines that the safety code passes verification, the service provider device analyzes the digital certification to obtain a device identification code of the user device. The service provider device obtains an order from a digital transaction management server system according to the device identification code of the user device to provide a service/product based on the order to the user device.

According to another embodiment, a digital transaction method is provided. A user device instructs a digital transaction management server system to bind a device identification code of the user device and an order after the user device makes purchases with the digital transaction management server system and accordingly obtains the order. The user device generates a digital certification and a safety code, wherein the safety code varies according to a predetermined varying sequence during a predetermined time interval, and the digital certification includes a device identification code of the user device. A service provider electronically scans and verifies the safety code. If the safety code passes verification, then the service provider analyzes the digital certification to obtain the device identification code of the user device. The service provider obtains the order from the digital transaction management server system according to the device identification code of the user device to provide a service/product based on the order to the user device.

According to another embodiment, a user device for executing digital transaction is provided. The user device for executing digital transaction includes: a processor, a memory coupled to the processor, a memory storing a user end application, and a screen coupled to the processor. The processor loads in and executes the user end application to execute following functions. The user device instructs a digital transaction management server system to bind a device identification code of the user device and an order after the user device purchases with the digital transaction management server system and accordingly obtains the order. The processor generates a digital certification and a safety code and further displays the digital certification and the safety code on the screen, wherein the safety code varies according to a predetermined varying sequence during a predetermined time interval. After the safety code passes through an electronic verification of a service provider, the user device requests the service provider to settle an electronic transaction.

According to another embodiment, a service provider device for digital transaction is provided. The service provider device for digital transaction includes: a processor; a memory coupled to the processor, a memory storing a service provider application, and a screen coupled to the processor. After the processor loads in and executes the service provider application, the processor executes following functions. After the user device generates a digital certification and a safety code, the service provider device scans the digital certification and the safety code, and the processor verifies whether the safety code varies according to a predetermined varying sequence during a predetermined time interval. If the processor determines that the safety code passes verification, the processor analyzes the digital certification to obtain a device identification code of the user device. The service provider device obtains an order from a digital transaction management server system according to the device identification code of the user device to provide a service/product based on the order to the user device.

According to another embodiment, a digital transaction management server system for digital transaction is provided. The digital transaction management server system for digital transaction includes: a user management module, an online shopping website and a service provider management module. After a user uses the user device to purchase on the online shopping website and accordingly obtains an order, the user management module binds a device identification code of the user device stored in a management database and the order. After the service provider management module receives the device identification code of the user device from a service provider, the service provider management module provides the order to the service provider. If a safety code generated by the user device passes through an electronic verification of the service provider, the service provider analyzes the digital certification generated by the user device to obtain the device identification code of the user device.

The above and other contents of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of the user device which generates a digital certification and a safety code which varies with time according to an embodiment of the disclosure.

FIG. 2 shows a schematic diagram of a service provider device which verifies the digital certification and the safety code generated by the user device according to an embodiment of the disclosure.

FIGS. 3A-3D show different examples of safety codes according to an embodiment of the disclosure.

FIGS. 4A-4C show a flow for a user to purchase an electronic ticket according to an embodiment of the disclosure.

FIGS. 5A-5C show a flow for a user to request the purchased service/product to be settled according to an embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other examples, well-known structures and devices are schematically shown in order to simplify the drawing.

### DETAILED DESCRIPTION

Technical terms are used in the specification with reference to generally-known terminologies used in the technology field. For any terms described or defined in the specification, the descriptions and definitions in the specification shall prevail.

Each embodiment of the present disclosure has one or more technical characteristics. In implementing, a person ordinarily skilled in the art can selectively implement or combine some or all of the technical characteristics of any embodiment of the present disclosure.

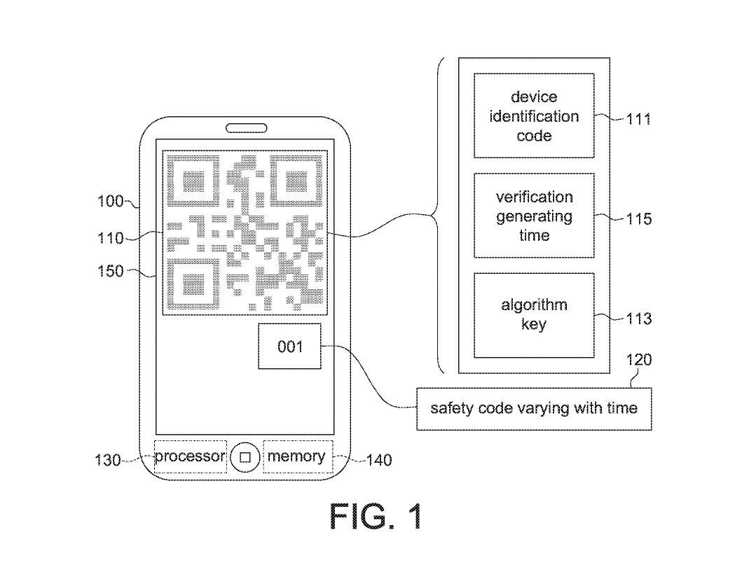

Referring to FIG. 1, a schematic diagram of a user device 100 generating a digital certification 110 and a safety code 120 which varies with time according to an embodiment of the disclosure is shown. The user device 100 downloads a user end application from a digital transaction management server system (shown in the subsequent drawing) according to an embodiment of the disclosure. The user may purchase a product or service from the digital transaction management server system via the user device 100. When the user consumes at the service provider and asks the service provider to provide product or service, the user end application may generate the digital certification 110 and the safety code 120 which varies with time in an off-line manner and further displays the digital certification 110 and the safety code on the screen of the user device 100 in a real-time manner. In another possible embodiment of the disclosure, the user end application may generate the digital certification 110 and the safety code 120 which varies with time in an on-line manner and further displays the digital certification 110 and the safety code on the screen of the user device 100 in a real-time manner, and such design is still within the spirit of the disclosure.

The digital certification 110 may include information such as a device identification code 111 of the user device, an algorithm key 113 and a verification generating time information 115. For example, the user end application encrypts the 3 items of information as the digital certification 110 by the hashing and encryption algorithms.

Exemplarily but not restrictively, the device identification code 111 of the user device includes a hardware identification code of the user device (such as a CPU serial number, a wireless network card serial number, and so on) and a network location of the user device. The device identification code 111 of the user device is obtained from the operating system of the user device by the user end application.

The algorithm key 113 includes an algorithm by which the user end application generates the safety code 120 and an algorithm by which the user end application generates the digital certification. In an embodiment of the disclosure, the user end application may use one of the default algorithms to generate the safety code 120. The type or the corresponding number of the algorithm used by the user end application is included in the digital certification 110 by the user end application. When the service provider successfully reads the digital certification 110, the service provider may obtain the type of the algorithm by which the digital certification 110 and the safety code are generated. Different safety code generating algorithm generates different safety codes and different sequences. The service provider may achieve anti-counterfeiting function by verifying the safety code generated by the user end application. If the safety code and its sequence generated by the user end application do not correspond to the safety code and its sequence specified in the algorithm which the service provider reads from the digital certification 110, then the service provider determines that the digital certification 110 is counterfeited.

The verification generating time information 115 includes the time point at which the user end application generates the digital certification 110. In an embodiment of the disclosure, the service provider will compare the time point at which the user device 100 generates the digital certification 110 and the time point at which the digital certification 110 is read/scanned by the service provider. If the difference between the two time points is over the predetermined threshold, then the service provider also determines that the digital certification 110 is counterfeited.

In a reasonable situation of use, after the user device 100 reaches the service provider, the user end application of the user device 100 generates the digital certification 110 and the safety code 120 and further displays the digital certification 110 and the safety code 120 to the service provider. Then, the service provider reads/scans the digital certification 110 and the safety code 120. Therefore, in a reasonable situation of use, the difference between the time point at which the user device 100 generates the digital certification 110 (such as 1:00:20 pm on the same day) and the time point at which the service provider reads/scans the digital certification 110 (such as 1:03:20 pm on the same day) should be smaller than a predetermined threshold. In an embodiment of the disclosure, the comparison of time difference assures that the user uses the user device 100 to generate the digital certification 110 only when the user wants to receive the service/product from the service provider, hence avoiding the digital certification 110 being counterfeited.

Also, in an embodiment of the disclosure, the verification generating time information 115 is optional. That is, the digital certification 110 may optionally include the verification generating time information 115.

In the present embodiment, the digital certification 110 may be realized by a 2-dimensional bar code (QR-code), but the disclosure is not limited thereto.

In other possible embodiments of the present disclosure, the digital certification 110 may further selectively include such as user's current geographical position information, and such design is still within the spirit of the disclosure.

In an embodiment of the disclosure as indicated in FIG. 1, the user device 100 at least includes a processor 130, a memory 140 and a screen 150. The memory 140 stores the user end application. After the processor 130 loads in and executes the user end application, the processor 130 may generate the digital certification and the safety code in an off-line or an on-line manner, and may further display the digital certification and the safety code on the screen 150.

Details of the safety code 120 which varies with time are disclosed below.

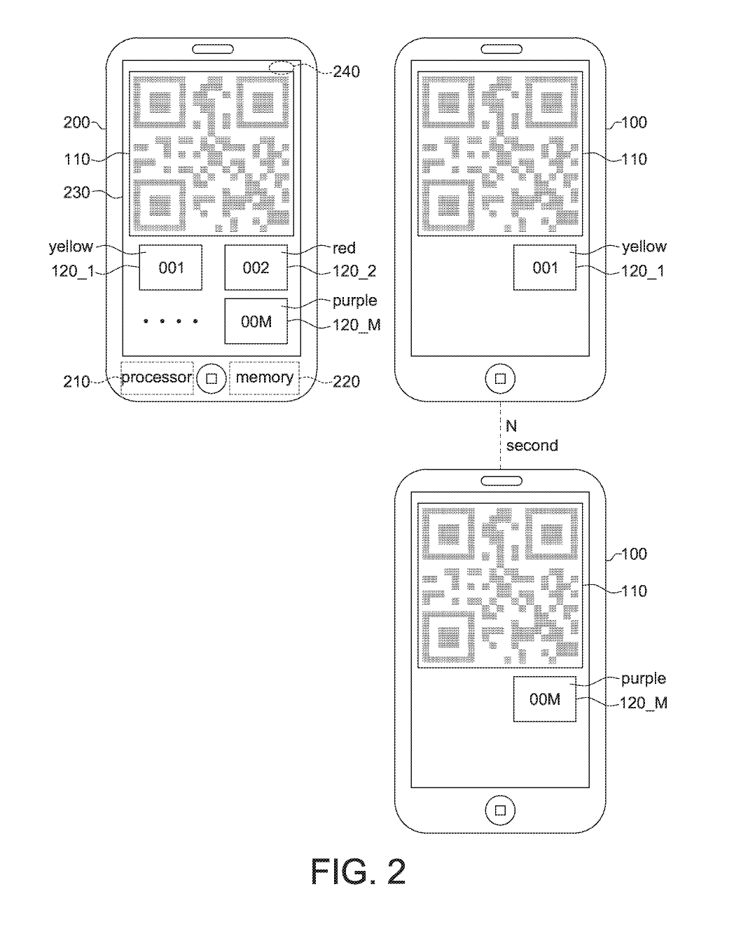

Referring to FIG. 2, a schematic diagram of a service provider device 200 which verifies the digital certification 110 and the safety code 120 generated by the user device 100 according to an embodiment of the disclosure is shown. As indicated in FIG. 2, the user device 100 sequentially generates M safety codes 120_1-120_M (M is a positive integer) within the predetermined time interval of N seconds (N is a positive integer) when the user device 100 generates the digital certification 110 and the safety code 120. The safety code 120_1 is, for example, a yellow region including digits 001; the safety code 120_2 is, for example, a red region including digits 002; . . . the safety code 120_M is, for example, a purple region including digits 00M.

When the user device 100 displays the digital certification 110 and the safety code 120 to the service provider device 200, the service provider application of the service provider device 200 scans the digital certification 110 and the safety code 120, and further reads/scans and identifies all safety codes 120_1-120_M generated by the user device 100. The service provider device 200 further displays all the scanned safety codes for verification of the safety codes.

The service provider device 200 analyzes the digital certification 110 to obtain the device identification code 111 of the user device, the algorithm key 113 and the verification generating time information 115. The service provider device 200 verifies whether the read safety code and its sequence match the safety code and its sequence specified in the algorithm type according to the algorithm types included in the algorithm key 113. That is, after the service provider device 200 analyzes the algorithm type, the service provider device 200 obtains the specified safety code and its sequence. Then, the service provider device 200 compares the safety code and its sequence read by the user device 100 to determine whether the read safety code and its sequence match the specified algorithm.

For example, suppose the generation sequence of the safety code specified in the algorithm analyzed by the service provider device 200 indicates: the first safety code is a yellow region including digits 001, the second safety code is a red region including digits 002, . . . , and the M-th safety code is a purple region including digits 00M. Then, the service provider device 200 compares this with the safety code and its sequence read from the user device 100. If matched, the safety code generated by the user device 100 of FIG. 2 passes verification.

Conversely, suppose the generation sequence of the safety code specified in the algorithm analyzed by the service provider device 200 indicates: the first safety code is a red region including alphabet R, the second safety code is a green region including alphabet G, . . . , and the M-th safety code is a blue region including alphabet B. The service provider device 200 compares this with the safety code read from the user device 100 and its sequence. Then, it is determined that the safety code generated by the user device 100 of FIG. 2 does not pass verification.

Furthermore, the service provider device 200 compares the time point at which the user device 100 generates the digital certification 110 and the time point at which the digital certification 110 is scanned by the service provider device 200, and further determines whether the difference between the two time points is smaller than a predetermined threshold.

Through comparison, if the service provider device 200 confirms that the safety code 120 can pass verification, and the difference between the generation time and the scan time is smaller than the predetermined threshold, then the service provider device 200 determines that the digital certification 110 generated by the user device 100 passes verification. Then, the service provider device 200 reads a user order from the digital transaction management server system according to the device identification code 111 of the user device and provides a product/service based on the order to the user device 100.

It is noted that in an embodiment of the disclosure, during the period at which the service provider device 200 scans the safety code 120, the digital certification 110 does not vary with time.

As indicated in FIG. 2, in an embodiment of the disclosure, the service provider device 200 displays all of the scanned safety codes 120_1-120_M on the screen for the comparison of safety codes.

In an embodiment of the disclosure as indicated in FIG. 2, the service provider device 200 at least includes a processor 210, a memory 220, a screen 230 and an image reading unit 240. The memory 220 stores a service provider application. After the processor 210 loads in and executes the service provider application, the processor 210 controls the image reading unit 240 to scan and identify the digital certification and the safety code which are generated by the user device 100. If the processor 210 determines that the safety code passes verification, then the processor 210 analyzes the digital certification and obtains a device identification code of the user and a user account, and further obtains order information from the digital transaction management server system according to the device identification code of the user and the user account to provide a product/service based on the order to the user.

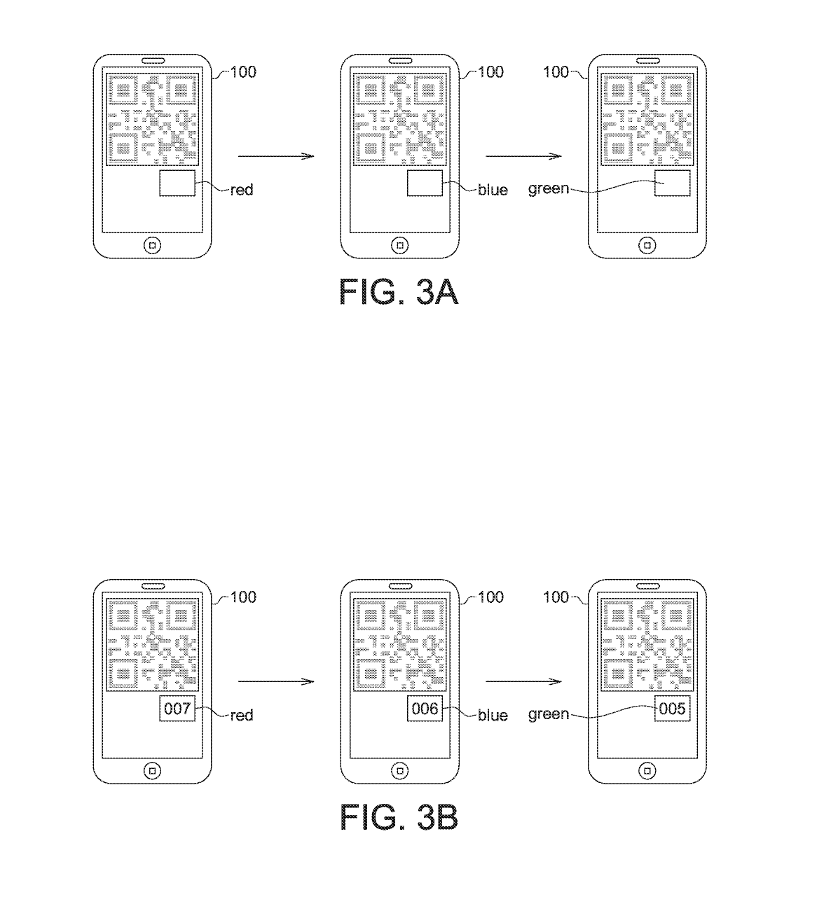

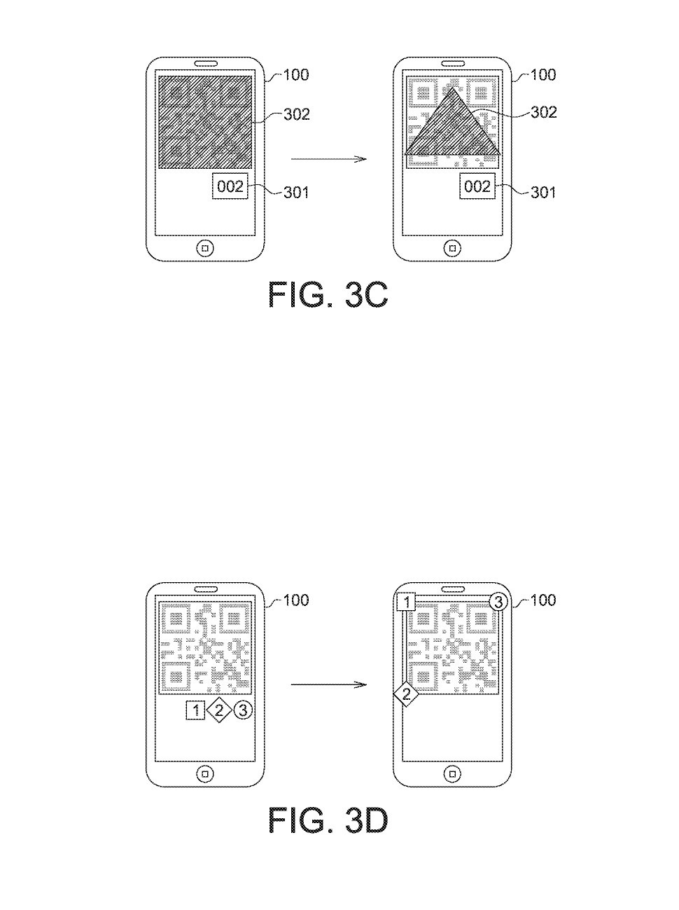

In an embodiment of the disclosure, the encoding logic of the safety code may be realized by a combination of different colors as indicated in FIG. 3A. For example, the first safety code is represented in red, the second safety code is represented in blue, and the third safety code is represented in green.

Or, the encoding logic of the safety code can be realized by a combination of different strings including character/digit/alphabet/symbol. For example, the first safety code is represented by digits 001, the second safety code is represented by digits 002, and the third safety code is represented by digits 003.

Or, the encoding logic of the safety code can be realized by a combination of colors and countdown digits as indicated in FIG. 3B. For example, the first safety code is represented by red digits 007, the second safety code is represented by blue digits 006, and the third safety code is represented by green digits 005.

Or, the safety code can be realized by other implementations as indicated in FIG. 3C and FIG. 3D. As indicated in FIG. 3C, the safety code includes a string 301 and a color block 302. The string 301 may or may not vary with time. The shape of the color block 302 varies with time. That is, at a particular time point, the color block 302 is, for example, a squared green block, while in another time point, the color block can change to a triangular red block.

FIG. 3D shows that the safety code may be a combination of strings, shapes, colors and distribution locations. That is, at a time point, the safety code includes a combination of the same or different colors and the same or different strings distributed at the bottom right corner of the digital certification. At another time point, the safety code includes a combination of the same or different colors and the same or different strings distributed at one or more than one corners of the digital certification.

In other embodiments of the disclosure, the safety code may include another 2-dimensional bar code (referred as security 2-dimensional bar code), which is different from the digital certification 110. The security 2-dimensional bar code is generated according to the encoding logic of the safety code, but varies with time during the scan time of the service provider. As disclosed above, the digital certification 110 is obtained by the user end application, which encrypts the device identification code 111, the algorithm key 113 and the verification generating time information 115 using the hashing and encryption algorithms, and does not vary with time during the scan time of the service provider.

In other embodiments of the disclosure, the safety code may include patterns or a combination of patterns, or a combination of pattern/string/color/spread location, and is still within the spirit of the disclosure.

That is, in an embodiment of the disclosure, the service provider device 200 verifies whether the scanned safety code varies according to a predetermined varying sequence during a predetermined time interval. If so, it is determined that the safety code passes verification.

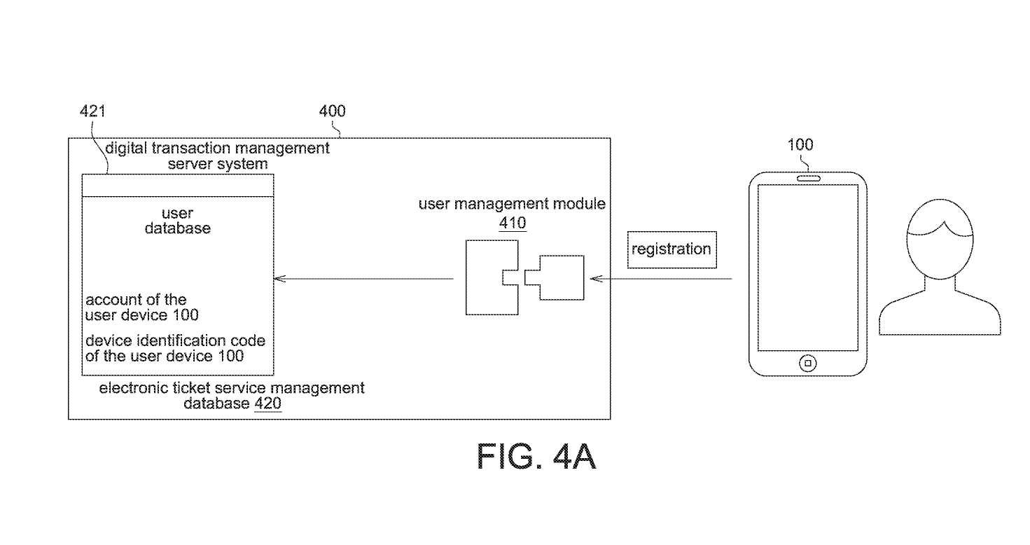

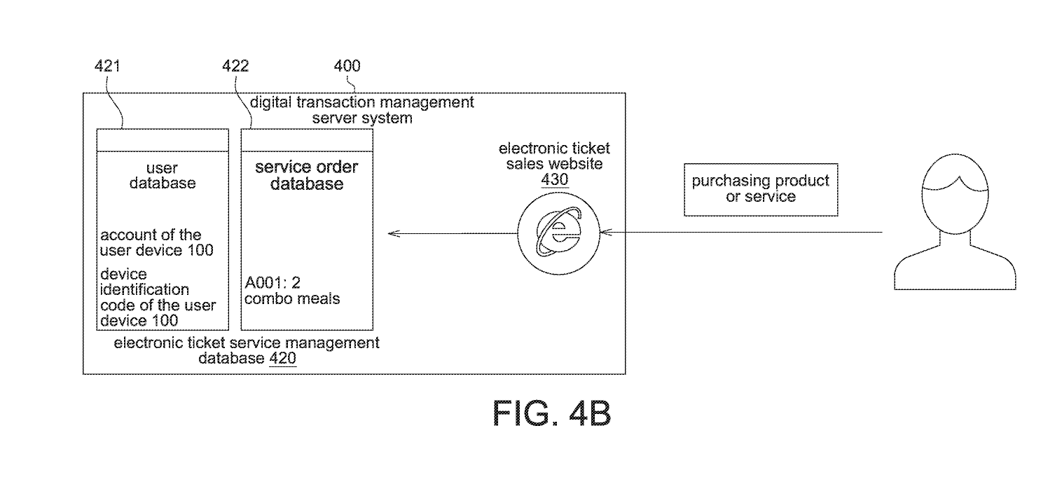

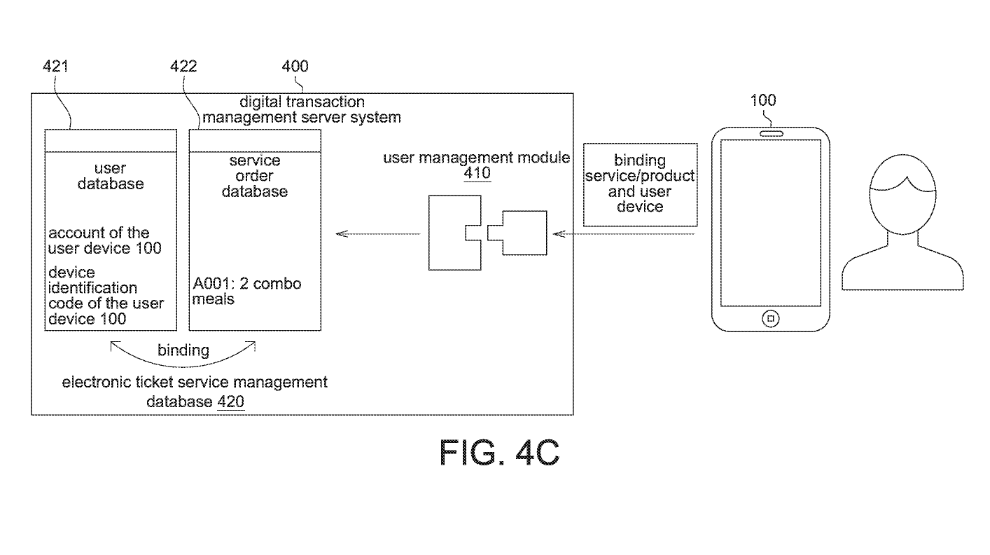

Referring to FIG. 4A-4C, a flow for a user to purchase an electronic ticket according to an embodiment of the disclosure is shown. After the user device 100 downloads the user end application, the user device 100 registers into the user management module 410 of the digital transaction management server system 400. The registration includes an account of the user device 100 and a device identification code of the user device 100. The user management module 410 stores the account of the user device 100 and the device identification code of the user device 100 into a user database 421 of the electronic ticket service management database 420.

If the user wants to purchase a product or service, the user can log in the electronic ticket sales website 430 of the digital transaction management server system 400 through the user device 100 to purchase the product or service. Suppose the user purchases 2 combo meals and the corresponding voucher number is A001. Then the electronic ticket sales website 430 stores the order related information to a service order database 422.

The user binds the purchased service/product with the user device 100 via the user management module 410. Then, the account and the device identification code of the user device 100 of the user database 421 of the electronic ticket service management database 420 are bound with the current order related information of the service order database 422.

That is, in an embodiment of the disclosure, the product/service purchased by the user is already bound with the user device 100. Although other people realize that the user has purchased a service/product from the digital transaction management server system 400, other people do not have the user device 100 and therefore cannot request the service provider to settle the purchased service/product. Therefore, the counterfeiting performance of the electronic ticket is greatly enhanced.

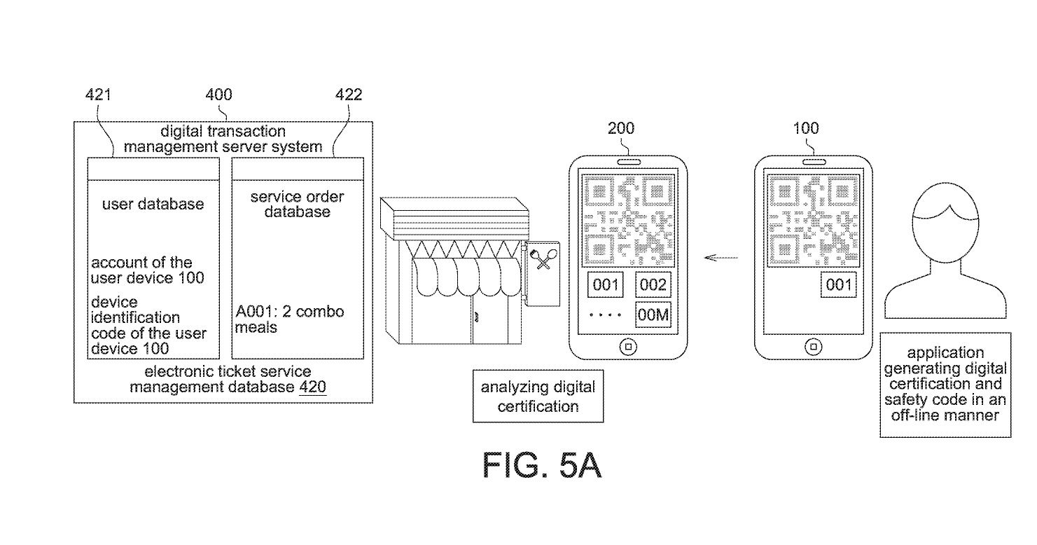

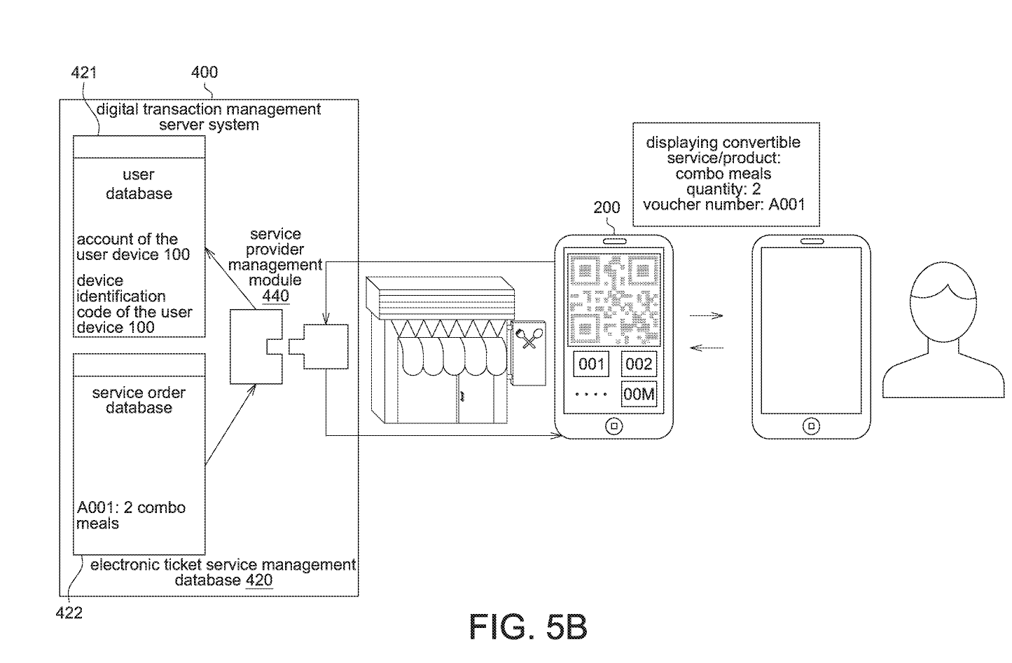

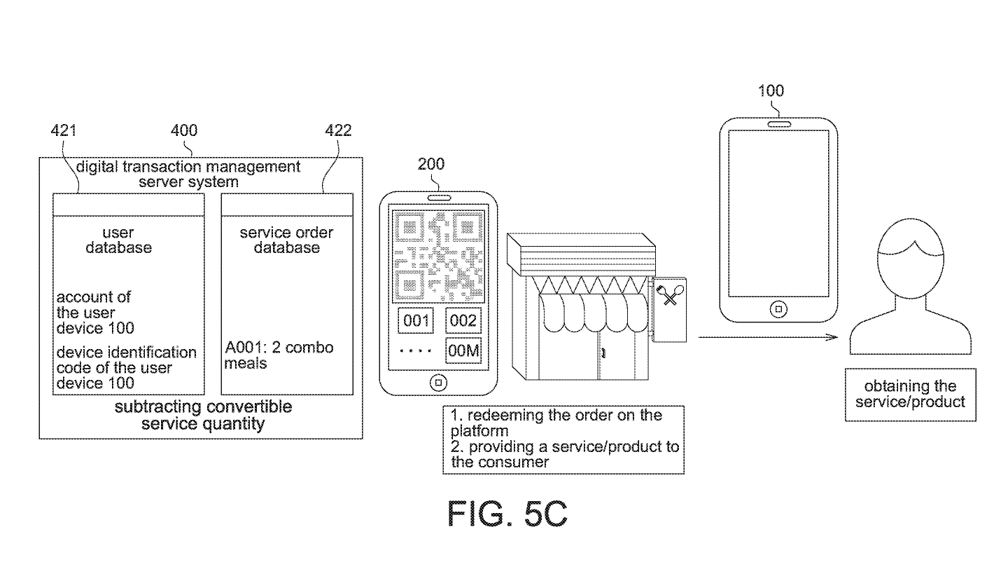

Referring to FIG. 5A-5C, a flow for a user to request the purchased service/product to be settled according to an embodiment of the disclosure is shown. The user, who requests to the purchased service/product to be settled, may bring the user device 100 to the server end. The application of the user device 100 generates the digital certification 110 and the safety code 120. The service provider device 200 verifies the digital certification 110 and the safety code 120 which are generated by the user device 100. If the verification is successful, then the service provider device 200 analyzes the digital certification 110 to obtain a device identification code of the user device 100.

The service provider device 200 may connect to the service provider management module 440 of the digital transaction management server system 400 via Internet to provide the device identification code of the user device 100 to the service provider management module 440. After inquiring the user database 421 and the service order database 422, the service provider management module 440 obtains the order A001 of 2 combo meals which are bound with the user device 100.

Then, the service provider device 200 displays the user's convertible service/product.

After the service provider provides the product/service to the user, the service provider device 200 may redeem the service on the digital transaction management server system 400. The user may even choose to obtain only a portion of the product/service. For example, if the user only takes away 1 combo meal, then the service provider device 200 connects to the service provider management module 440 to update the user's order A001 to 1 combo meal.

In an embodiment of the disclosure, after the user device 100 purchases a service/product, the user device 100 can bind the order to another user device account (that is, a gift). For example, after a son purchases a service of oversea travelling, the son can bind the order to his father's account (the father needs to complete registration beforehand). Then, the father can bring his mobile cell to the service end and requests the service provider to settle the service of oversea travelling.

In an embodiment of the disclosure, the internal modules of the digital transaction management server system 400 (that is, the user management module 410, the electronic ticket service management database 420, the electronic ticket sales website 430 and the service provider management module 440) can be realized by way of hardware or software, and are all within the spirit of the disclosure.

As disclosed above, the user device can generate the digital certification and the safety code in an off-line manner, but the disclosure is not limited thereto. Therefore, even when network connection is unavailable, the user device still can generate an electronic ticket and obtains the product/service, making it more convenient for the user to obtain the product/service.

The user device generates the electronic ticket at the service provider which verifies whether the safety code is correct by an analyzed algorithm. Such verification is completed by the application of the service provider device. Therefore, the service provider can reduce the counterfeit of electronic tickets. Since the verification is automatically completed by the service provider device, the verification time is short and the user can spend less time waiting for the result of verification. Since the verification is automatically completed by the service provider device, the staff or owner of the service provider do not need to manually judge the authenticity of the electronic tickets with their eyes, and the misjudgment of the service provider can be reduced.

Any service/product which may be sold on Internet may also be bought by user on Internet according to an embodiment of the disclosure. Therefore, the embodiment of the disclosure expands the application field of retailing service.

The electronic ticket of an embodiment of the disclosure is generated only when the user requests the purchased product/service to be settled. Therefore, the user does not need to worry that the electronic ticket might get lost like a paper voucher or worry about the safekeeping of a large volume of paper vouchers. That is, although the user purchases many services/products, the required electronic ticket can always be generated immediately whenever the user needs it.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A digital transaction method, applied in a user device, comprising:
instructing, by the user device, a digital transaction management server system to bind a device identification code of the user device and an order, after the user device purchases with the digital transaction management server system and accordingly obtains the order;
generating, by the user device, a digital certification and a safety code, wherein the safety code varies according to a predetermined varying sequence during a predetermined time interval; and
requesting, by the user device, a service provider to settle an electronic transaction based on the order after the safety code passes through an electronic verification by the service provider.

2. The digital transaction method according to claim 1, wherein
the user device generates the digital certification and the safety code in an off-line or an on-line manner.

3. The digital transaction method according to claim 1, wherein
the digital certification is invariable during the predetermined time interval.

4. The digital transaction method according to claim 1, further comprising:
registering, by the user device, into the digital transaction management server system to bind the device identification code of the user device and a user account.

5. The digital transaction method according to claim 1, wherein
the digital certification comprises: the device identification code of the user device and an algorithm related information.

6. The digital transaction method according to claim 5, wherein
the digital certification further comprises a verification generating time information and a user's current geographical position information.

7. The digital transaction method according to claim 5, wherein
the algorithm related information specifies an algorithm type used for generating the digital certification and the safety code.

8. The digital transaction method according to claim 1, wherein
the safety code comprises a combination of color, string, pattern, color block and security 2-dimensional bar code, and the combination varies according to the predetermined varying sequence during the predetermined time interval.

9. A digital transaction method, applied in a service provider device, comprising:
after a user device generates a digital certification and a safety code, scanning, by the service provider device, the digital certification and the safety code to verify whether the safety code varies according to a predetermined varying sequence during a predetermined time interval;
analyzing, by the service provider device, the digital certification to obtain a device identification code of the user device if the service provider device determines that the safety code passes verification; and
obtaining, by the service provider device, an order from a digital transaction management server system according to the device identification code of the user device to provide a service/product based on the order to the user device.

10. The digital transaction method according to claim 9, wherein
analyzing, by the service provider device, the digital certification to obtain an algorithm related information, which specifies the predetermined varying sequence of the safety code during the predetermined time interval.

11. The digital transaction method according to claim 9, further comprising:
analyzing, by the service provider device, the digital certification to obtain a verification generating time information at which the user device generates the digital certification; and
determining, by the service provider device, whether a time difference between the verification generating time information and a verification read/scan time at which the service provider device reads/scans the digital certification is smaller than a predetermined threshold to determine whether the user device passes verification.

12. The digital transaction method according to claim 9, wherein
the user device generates a plurality of different safety codes during the predetermined time interval;
the service provider device displays all of the safety codes for verification of the safety codes.

13. The digital transaction method according to claim 9, wherein
the safety code comprises an combination of color, string, pattern, color block and security 2-dimensional bar code; and
the service provider device verifies whether the combination varies according to the predetermined varying sequence during the predetermined time interval.

14. A digital transaction method, comprising:
instructing, by a user device, a digital transaction management server system to bind a device identification code of the user device and an order, after the user device purchases with the digital transaction management server system and accordingly obtains the order;
generating a digital certification and a safety code by the user device, wherein the safety code varies according to a predetermined varying sequence during a predetermined time interval, wherein the digital certification comprises the device identification code of the user device;
electronically scanning and verifying the safety code by a service provider;
analyzing, by the service provider, the digital certification to obtain the device identification code of the user device if the safety code passes verification; and
obtaining, by the service provider, the order from the digital transaction management server system according to the device identification code of the user device to provide a service/product based on the order to the user device.

15. A user device, used for executing digital transaction, comprising:
a processor;
a memory coupled to the processor and storing a user end application; and
a screen coupled to the processor,
wherein after the processor loads in and executes the user end application,
the user device instructs a digital transaction management server system to bind a device identification code of the user device and an order after the user device purchases with the digital transaction management server system and accordingly obtains the order;
the processor generates a digital certification and a safety code and further displays the digital certification and the safety code on the screen, wherein the safety code varies according to a predetermined varying sequence during a predetermined time interval; and
the user device requests a service provider to settle an electronic transaction after the safety code passes through an electronic verification of the service provider.

16. The user device according to claim 15, wherein
the processor generates the digital certification and the safety code in an off-line or an on-line manner.

17. The user device according to claim 15, wherein
the digital certification is invariable during the predetermined time interval.

18. The user device according to claim 15, further comprising:
the user device registers into the digital transaction management server system to bind the device identification code of the user device and a user account.

19. The user device according to claim 15, wherein
the digital certification comprises the device identification code of the user device and an algorithm related information.

20. The user device according to claim 19, wherein
the digital certification further comprises a verification generating time information and a user's current geographical position information.

21. The user device according to claim 19, wherein
the algorithm related information specifies an algorithm type used for generating the digital certification and the safety code.

22. The user device according to claim 15, wherein
the safety code comprises a combination of color, string, pattern, color block and security 2-dimensional bar code, and the combination varies according to the predetermined varying sequence during the predetermined time interval.

23. A service provider device, used for digital transaction, comprising:
a processor;
a memory coupled to the processor and storing a service provider application; and
a screen coupled to the processor,
wherein after the processor loads in and executes the service provider application,
after a user device generates a digital certification and a safety code, the service provider device scans the digital certification and the safety code, and the processor verifies whether the safety code varies according to a predetermined varying sequence during a predetermined time interval;
if the processor determines that the safety code passes verification, then the processor analyzes the digital certification to obtain a device identification code of the user device; and
the service provider device obtains an order from a digital transaction management server system according to the device identification code of the user device to provide a service/product based on the order to the user device.

24. The service provider device according to claim 23, wherein
the processor analyzes the digital certification to obtain an algorithm related information, which specifies the predetermined varying sequence of the safety code during the predetermined time interval.

25. The service provider device according to claim 23, further comprising:
the processor analyzes the digital certification to obtain a verification generating time information; and
the processor determines whether a time difference between the verification generating time information and a verification read/scanned time is smaller than a predetermined threshold to determine whether the user device passes verification.

26. The service provider device according to claim 23, wherein
the user device generates a plurality of different safety codes during the predetermined time interval;
the processor displays all of the safety codes on the screen for the verification of the safety codes.

27. The service provider device according to claim 23, wherein
the safety code comprises an combination of color, string, pattern, color block and security 2-dimensional bar code; and
the service provider device verifies whether the combination varies according to the predetermined varying sequence during the predetermined time interval.

28. A digital transaction management server system, used for digital transaction, comprising:
a user management module;
an online shopping website; and
a service provider management module;
wherein
after a user device purchases on the online shopping website and accordingly obtains an order, the user management module binds a device identification code of the user device stored in a management database and the order;
after the service provider management module receives the device identification code of the user device from a service provider, the service provider management module provides the order to the service provider,
wherein if a safety code generated by the user device passes through an electronic verification of the service provider, then the service provider analyzes a digital certification generated by the user device to obtain the device identification code of the user device.

29. The digital transaction management server system according to claim 28, wherein:
the management database storing the order, the device identification code of the user device, and a user account of the user device.
